(19) United States
(12) Patent Application Publication
(10) Pub. No.: US 2005/0004893 A1
(43) Pub. Date: Jan. 6, 2005

(54) Workflow management devices and systems, and workflow assignment and management methods

(76) Inventor: James M. Sangroniz, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/613,059

(22) Filed: Jul. 2, 2003

(51) Int. Cl. G06F 7/00

(52) U.S. Cl. 707/3

(57) ABSTRACT

Aspects of the invention relate to workflow management devices, workflow management systems, workflow management methods, workflow assignment methods, and data processing methods. In one aspect, a workflow management device includes a communications interface configured to receive a user request having one or more user-desired product properties to achieve a user-desired product. The communications interface is further configured to communicate with one or more devices located external of the workflow management device. The management device also includes a storage device configured to store data for processing the user request, and processing circuitry configured to process the user request using the data to produce a transformed user request. The transformed user request includes information for automatically organizing workflow to process the one or more user-desired product properties to achieve the user-desired product.

### FIELD OF THE INVENTION

Aspects of the invention relate to workflow management devices, workflow management systems, workflow management methods, workflow assignment methods, data processing methods, printing and articles of manufacture.

### BACKGROUND OF THE INVENTION

Workflow systems are often defined for work which is basically clerical in nature, therefore requiring a simple user interface, and also requiring that the person performing the work be unconcerned with where the work came from or where the work goes to after they have performed their particular part of the activity. Prior art workflow systems provide a definition of each activity to be performed during the process, and provide routing information to allow work to be routed from one person to another between activities.

Prior approaches fail to provide a procedure that is defined in an ad-hoc manner for processing job requests from users. Prior approaches also fail to disclose a procedure for automatically deciding how a job should be processed by a processing entity in order to fulfill the desires of a person submitting the job. Prior approaches further fail to disclose a workflow system that provides a separation between the decision making area of the system and the information movement area of the system.

### SUMMARY OF THE INVENTION

At least some embodiments of the invention relate to workflow management devices, workflow management systems, workflow management methods, workflow assignment methods, data processing methods, and articles of manufacture.

In one aspect, a workflow management device includes a communications interface configured to receive a user request having one or more user-desired product properties to achieve a user-desired product. The communications interface is further configured to communicate with one or more devices located external of the workflow management device. The management device also includes a storage device configured to store data for processing the user request, and processing circuitry configured to process the user request using the data to produce a transformed user request. The transformed user request includes information for automatically organizing workflow to process the one or more user-desired product properties to achieve the user-desired product.

In another aspect, a workflow processing device is described. The workflow processing device includes a stylesheet having defined rules for processing a user request. The device also includes processing circuitry configured to receive the user request, load the defined rules, and execute the defined rules to create a transformed request. The transformed request includes instructions to automatically organize workflow to efficiently process the user request.

In yet another aspect, a workflow assignment method is described. The method includes receiving a user request, the request having one or more user-desired product properties, creating a stylesheet having defined rules for processing the user request. The method also includes loading the defined rules and the user request into a processing circuitry configured to process the user request, and executing the defined rules to create a transformed user request. The transformed user request includes definition of workflow tasks to be performed, settings and properties for those workflow tasks, as well as the one or more user-desired product properties to produce a user-desired product.

Other aspects of the invention are disclosed herein as is apparent from the following description and figures.

### DESCRIPTION OF THE DRAWINGS

FIG. 1 is a functional block diagram of a workflow management system according to one embodiment.

FIG. 2 is a functional block diagram of a workflow management device according to one embodiment.

FIG. 3 is a functional block diagram of processing circuitry of a workflow management device according to one embodiment.

FIG. 4 is a flow chart for generating a modified job request from an input job request to control workflow in a workflow management system according to one embodiment.

### DETAILED DESCRIPTION OF THE INVENTION

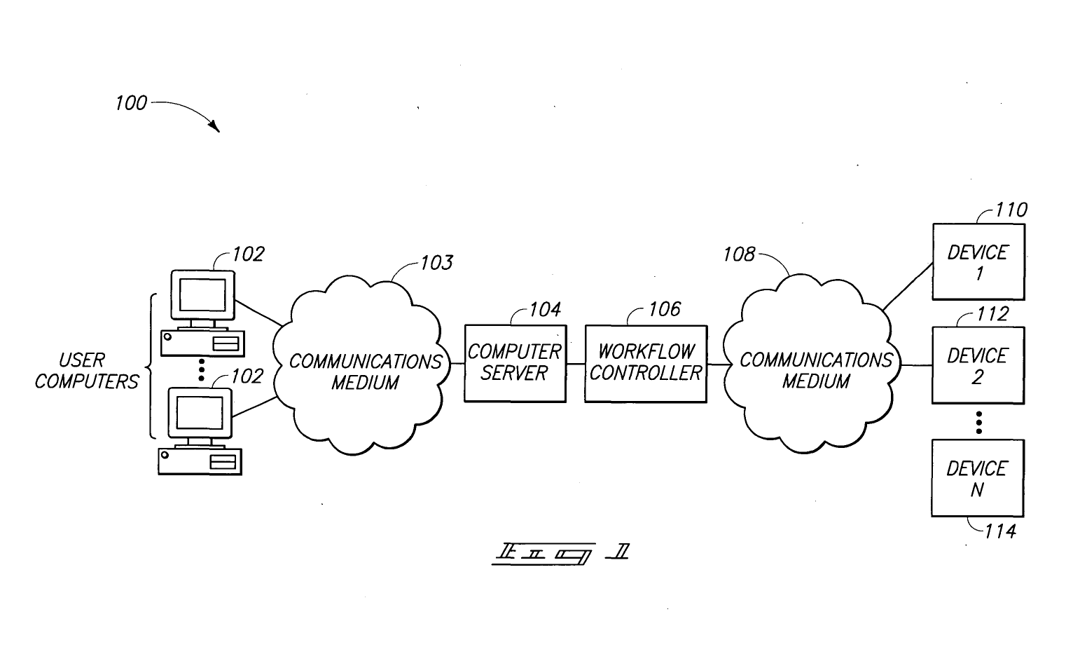

Referring to FIG. 1, an exemplary workflow management system 100 arranged according to one embodiment is shown. The depicted workflow management system 100 includes one or more user computers 102, a communications medium 103, a computer server 104, a workflow controller 106, a communications medium 108, and a plurality of processing devices 110, 112, 114, respectively. In one arrangement, at least some or all of devices 102, 104, 106, and 110-114 are provided at locations physically separated from one another.

Individual ones of user computers 102 may be configured by a user to send a request to the computer server 104 for processing, and the processed request may be executed by the controller 106 by appropriately routing the request made by the user to processing devices 110, 112, or 114, the routing of request based on user-desired product properties (e.g., properties desired by the user in a product). For simplicity and ease of illustration, reference would be made to a single user using computer 102. It will however be appreciated that requests from several users may be sent to the computer server 104 simultaneously, or at different times.

In one embodiment, a request from a computer 102 may be received as an input job request (e.g., intention job ticket) by the computer server 104 for further processing. For example, the input job request may include a request to produce a user-desired product. The input job request includes information regarding desires of the user for the product having the one or more user-desired product properties. Additional information required for processing the input request is added by the computer server 104.

The input job request from a computer 102 may be received in one of several ways. In some embodiments, the input job request may be made as a business-to-business transaction. This is, for example, a web service type of transaction, wherein the computer server 104 is configured to provide a user interface, to a user of the computer 102 via a communications medium 103. The user interface enables the user to make a selection from information displayed on the computer 102. In some embodiments, information from the user at computer 102 may be input in a job definition format (JDF). Further details of the JDF format are disclosed at www.cip4.org. The details of the JDF format as disclosed on that website are incorporated herein by reference in their entirety. Other ways of inputting information by a user into the computer server 104 are possible. For example, if a user desires processing of a job request, then such a request may be directly received by the computer server 104 without a need for a communication medium (e.g., 103) for routing the user request.

In one embodiment, the workflow controller 106 may be a computer configured to receive information processed by the computer server 104 to implement the user-desired product properties by appropriately routing the input job request to devices 110-114 for processing. For example, depending on the input job request, having one or more user-desired product properties received from the user at computer 102, the computer server 104 may process the input job request to add additional information that may be necessary to produce the user-desired product (e.g., how the input job request should be processed, should printing be performed in color or black and white, should a finished product be punched with 2 holes or 3 holes, paper-type on which a user desires a final product to be printed, through which processes the job must be routed, the order of processing (workflow), etc.), thus producing an output job request. In the disclosure herein, workflow generally refers to an order of routing a user request (e.g., an input job request) through one or more processing devices (e.g., devices 110-114) for processing.

In another embodiment, the computer server 104 may be configured to perform tasks performed by the workflow controller 106 as noted above, thus preventing a need to have a separate workflow controller to implement user-desired product properties to produce a user-desired product.

Communications media 103, 108 are configured to implement communications between computers 102, computer server 104, workflow controller 106, and devices 110-114, respectively. Communications media 103, 108 may be configured in any suitable manner to provide communication of electronic data, programming or other information between communicatively coupled devices. For example, communications media 103, 108 may comprise private and/or public networks and networking components, (e.g., internet, an intranet, or any communications network using a TCP/IP protocol, and hardware such as network cards or other equipment, modems, and/or routers, etc.).

Devices 110-114, respectively, are selectively coupled to communications medium 108 to enable communication of information between the user at computer 102, the computer server 104, and the workflow controller 106. Devices 110-114 are configured to process the input job request made by the user at computer 102. The request is further processed by the computer server 104, and the workflow is controlled by the workflow controller 106 as described above.

In one example, the workflow management system 100 may be implemented in a print shop configured to perform a plurality of tasks, in order to create a product with all the user-desired product properties. Exemplary user requests include such user-desired properties as black and white or color printing, printing on a specific type of paper, performing finishing operations (e.g., a three hole punch, etc.), and collation. Other user-desired properties or combinations of properties desired by a user in a product are possible. The computer server 104 is configured to pre-process user-desired product properties so that the one or more devices 110-114 are configured to produce a user-desired product with the user-desired product properties. Examples of user computers, one or more devices configured to process the user requests etc. are for purposes of illustration only. Other combinations of computer server, controller, and processing devices are possible.

In the example of a print shop, the device 110 may be configured as a computer system for converting a file format of an output job request received from the workflow controller 108, (e.g., modified job request performing raster input processing, or other pre-processing tasks). After performing the pre-processing tasks on the modified job request, for example, by device 110, the resulting output from the device 110 may be routed to device 112 for further processing. For example, the device 112 may be a hard imaging device, such as a printer, for performing printing operations desired by the user. After performing printing tasks by the device 112, the resulting output from the device 112 may be routed to device 114 for further processing in accordance with the modified job request. For example, the device 114 may be configured as a finishing station to perform finishing operations, such as, for example, collating the printed product, making a three-hole punch in the printed product, etc. More or fewer devices than ones that are illustrated, to process a user request, are possible.

As noted above, in one embodiment, device 112 may be configured to form hard images. Hard images comprise images physically rendered upon output media, such as sheet paper, roll paper, envelopes, transparencies, labels, etc. Hard imaging devices may be implemented as laser printers, inkjet printers, impact printers, copiers, facsimile devices, multiple function peripheral (MFP) devices, or any other configuration arranged to form hard images.

The above noted example of a print shop and the configuration of the devices 110, 112, 114, as a computer system, hard imaging device, and finishing station, respectively, are merely exemplary to explain aspects of the invention. Other combinations of devices and reorganization of workflow (e.g., routing of tasks between devices 110-114 are possible). The routing of a task to fulfill an input job request by a user at computer 102 may be determined by the computer server 104 based on the one or more properties, desired by a user in a product, comprised within the input job request from the user at computer 102. It will be appreciated that workflow among devices 110-114 may depend on desires of a user submitting the input job request.

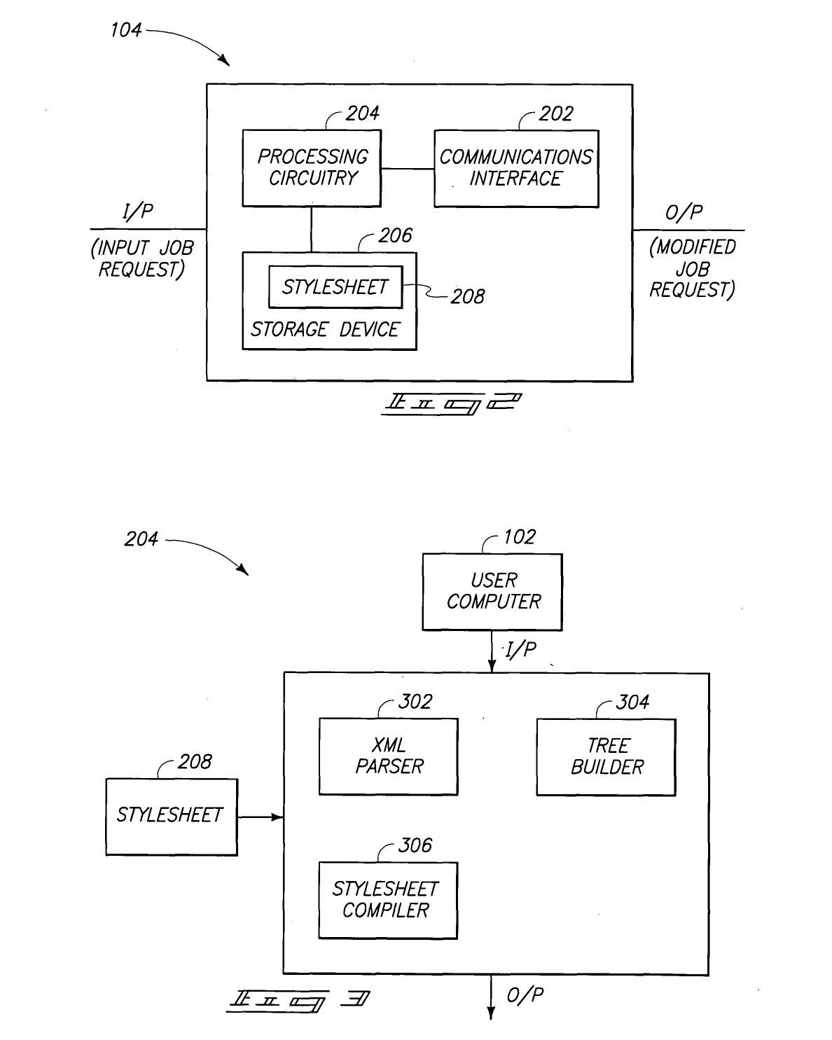

Referring to FIG. 2, further details are shown of a computer server 104 in accordance with certain embodiments. The server 104 is configured to receive an input job request from a user (e.g., user at computer 102), and process the input job request to create a modified job request. The modified job request has additional information to perform user-desired product properties. The illustrated computer server 104 includes a communications interface 202, processing circuitry 204, and a storage device 206.

Communications interface 202 is configured to communicate electronic data externally of the computer server 104. For example, the communications interface 202 enables communication with respect to communications medium 103, workflow controller 106, or communications medium 108. In one embodiment, communications interface 202 is arranged to provide input/output communications with respect to external devices (e.g., user computer 102, workflow controller 106). Communications interface 202 may comprise a parallel port, USB port, EIO slot, network interface card (e.g., JetDirect™), IEEE 1394 connector, and/or other appropriate configuration capable of communicating electronic data.

Processing circuitry 204 is configured to process data received as an input job request from a user (e.g., user of computer 102), the input job request comprising one or more user-desired product properties for processing by devices 110-114, respectively. As noted above, in one embodiment, the input job request may merely include information related to the desires of the user submitting the job request. The processing circuitry 204 is configured to retrieve rules data or rules definition data stored in a storage device 206, and upon identifying an instance (e.g., a user preference or desire as to how the input job request should be processed) execute a method as defined in the rules definition data corresponding to user desires or specifications. In one exemplary embodiment, the processing circuitry 204 comprises an XSLT processor, and the processing circuitry may be configured to apply XSL transformation to a user request to produce a transformed/modified job request. The rules may include additional information such as, for example, how the job should be processed, through which processes the job must flow, order of processing, etc. Additional information is added to the input job request to produce a modified job request having information that may be required to process the input job request from the user.

In some embodiments, the rules definition data is created using Extensible Stylesheet language (XLS), and the transformation of the input job request into a modified job request is performed using Extensible Stylesheet Transformation (XSLT). In one embodiment, the rules definition data or other instructions for processing the input job request from a user (e.g., user at computer 102) may be stored in a stylesheet in a storage device 206. In another embodiment, the rules definition data may be stored in a memory (not shown) of the server computer 104.

In one embodiment, rules definition data may be stored in the storage device 206, or as a stylesheet 208 in the storage device, by a manager or an administrator of the workflow management system 100 (FIG. 1).

The processing circuitry 204 may comprise circuitry configured to execute programming. In one example, processing circuitry 204 may be configured to include instructions or executable applications stored in the storage device 206 as a stylesheet 208 for executing a method defined by one or more rules, responsive to one or more properties desired by a user and submitted in an input job request to the computer server 104. Exemplary commands or executable applications include receiving the input job request having one or more user-desired product properties and parsing the received information to determine an order for processing such user-desired product properties. Further, the storage device 206 may be configured to store a plurality of rule definitions (e.g., workflow instructions) to process workflow to perform the one or more user-desired product properties, and apply a workflow that best matches the desires or specifications of the user. In one embodiment, each workflow may be stored in a stylesheet.

The computer server 104 is configured to create an output job request which includes a workflow map as well as user-desired product properties to produce a user-desired product. The workflow controller 106 (FIG. 1) may receive an output job request from the computer server 104 to control routing of information between the various devices (e.g., devices 110-114) configured to produce a user-desired product having the user-desired product properties.

In an exemplary embodiment, the processing circuitry 204 may be implemented as a microprocessor or other structure configured to execute executable applications of programming including, for example, software and/or firmware instructions. Other exemplary embodiments of processing circuitry 204 include hardware logic, PGA, FPGA, ASIC, and/or other structures. These examples of processing circuitry 204 are for illustration and other configurations are possible for implementing operations discussed herein.

Storage device 206 is configured to store electronic data, file systems having one or more electronic files (e.g., stylesheets 208) programming such as executable instructions (e.g., software and/or firmware), and/or other digital information and may include processor-usable media. Although a single stylesheet 208 is illustrated, it will be appreciated that more than one stylesheet may be stored in the storage device 206. Processor-usable media includes any article of manufacture which can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

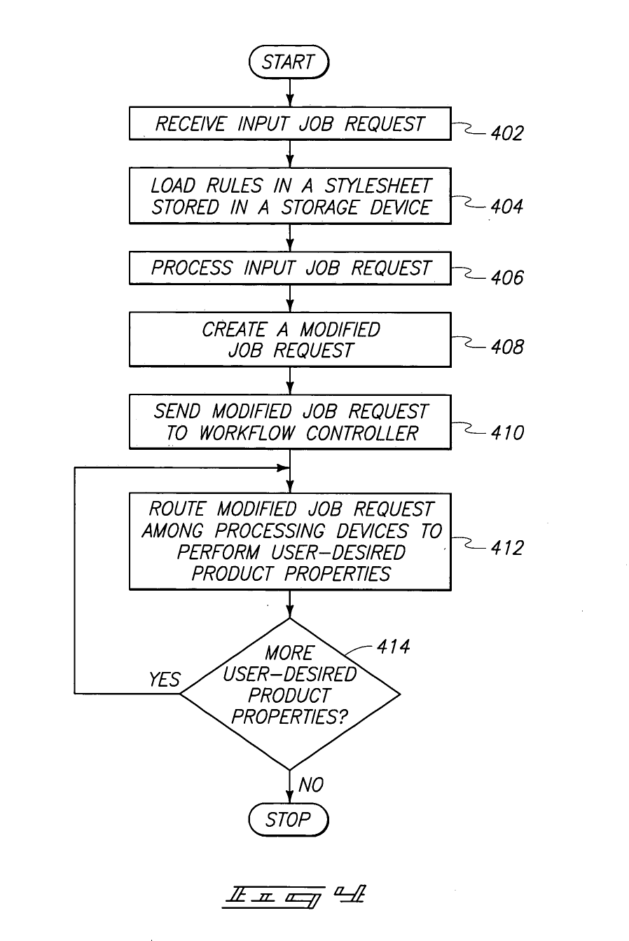

FIG. 3 shows an exemplary configuration of a processing circuitry 204. The processing circuitry comprises an XML parser 302, a tree builder 304, and a stylesheet compiler 306. The XML parser 302 may be configured to parse information received from a user (e.g., input job request from a user at computer 102). The tree builder 304 may be configured to receive the parsed information from the input job request and execute a method (e.g., a rule definition), stored in a stylesheet 208, corresponding to user-desired product properties. The stylesheet compiler 306 may be configured to receive information from the tree builder 304 and XML parser 302 to create a modified stylesheet that is output by the processing circuitry 204 as a modified job request having additional information than what was present in the input job request. The additional information may enable the processing circuitry 204 to route the workflow to one or more processing devices (e.g., devices 110-114) to perform the one or more user-desired product properties. In one embodiment, each of the components XML parser 302, tree builder 304, and stylesheet compiler 306 may be configured as software components.

Various workflows (e.g., processing sequences to process user requests) may be applied to an input job request from a user depending on desires or specifications of a user. For example, if the user desires processing of properties one and two desired in a product, then one set of instructions stored in the storage device (e.g., in the form of a stylesheet 208) may be found to be applicable to process such a user request, thus generating a certain workflow. On the other hand, if a user desires processing of properties one to three desired in a product, then a different set of instructions stored in a different stylesheet may be found to be applicable, thereby creating a different workflow. In one embodiment, irrespective of the workflow adopted to process a request from a user, the underlying software code responsible for performing the functions of parser 302, tree builder 304, and stylesheet compiler 306 may not have to be changed.

In another embodiment, after a request for processing a property or a specification desired by a user, in a given user-desired product, is received at one or more processing devices (e.g., devices 110-114), individual devices (e.g., 110-114) may process the received information using a set of rules or rules definitions that are local to a particular processing device. For example, consider device 110 to be a computer having a local storage device, and processing circuitry (not shown). In such an exemplary case, device 110 may be provided with one or more stylesheets stored in the local storage device, and the instructions stored in the stylesheets may be executed for processing tasks that are local to the device 110.

FIG. 4 is a flow chart for generating a modified job request from an input job request (e.g., intent job ticket) from a user to control workflow in a workflow management system 100 (FIG. 1) according to one embodiment. Other methods are possible including more, less or alternative steps.

At a step 402, an input job request sent by a user (e.g., a user at computer 102) is received by a computer server 104 (FIG. 1). As noted above, the input job request includes information related to one or more user-desired product properties the processing of which is sought from one or more processing devices (e.g., devices 110-114).

At a step 404, a manager of the workflow management system loads rules data in a storage device 206 (FIG. 3). The manager may also be provided with privileges to modify workflow to process the one or more user-desired product properties. In one embodiment, the rules data may be stored in a stylesheet 208 of the storage device 206. As noted above, one or more stylesheets 208 may be stored in the storage device 206.

At a step 406, the input job request from the user is processed using rules as defined in the one or more stylesheets in order to assemble a workflow for processing the input job request the by one or more processing devices (e.g., devices 110-114).

At a step 408, a modified job request is created using instructions from the one or more stylesheets, the modified job request having additional information (e.g., how to process the input job request, through which processing devices the input job request must be routed, the order of workflow, etc.) to process the user-desired product properties comprised in the input job request.

At a step 410, the modified job request is sent to a workflow controller 106 (FIG. 1).

At a step 412, the workflow controller 106 (FIG. 1) based on the additional information from the modified job request routes the input job request among the processing devices (e.g., devices 110-114) to perform the user-desired product properties.

At a step 414, an inquiry is made to determine if any more user-desired product properties are pending processing. If yes, step 412 is performed to perform the pending processing requests.

Exemplary advantages of some embodiments include: (i) automatic assignment of workflow to an input job request without any manual intervention, (ii) customization of logic to apply workflow to an input job request without customizing the software or recompiling the application software, (iii) customization of the number and types of workflows that can be applied to an input job request without recompiling application software, and (iv) customization of workflow may be performed using an industry standard (e.g., XSLT). Such standardization includes the following additional advantages: (a) more support may be available from standards bodies and user communities, (b) more documentation may be available from various resources, and (c) learning can be leveraged to other applications.

Other advantages include elimination of manual decision-making about how to process an input job request, thus providing for consistency and reduced human error. A mechanism is provided to customize the workflows that can be applied to an input job request, so that the solution may be applicable to many situations. A way is provided to customize the decision process of which workflow to apply to a specific input job request. Further, since the customization mechanism is industry standard, investments of time and effort in learning how to customize the workflow may be leveraged.

The protection sought is not to be limited to the disclosed embodiments, which are given by way of example only, but instead is to be limited only by the scope of the appended claims.

1. A workflow management device comprising:
a communications interface configured to receive a user request comprising one or more user-desired product properties to achieve a user-desired product, the interface further configured to communicate with one or more devices located external of the workflow management device;
a storage device configured to store data for processing the user request; and
processing circuitry configured to process the user request using the data to produce a transformed user request, the transformed user request including information for automatically organizing workflow to process the one or more user-desired product properties to achieve the user-desired product.

2. The device of claim 1, wherein the transformed user request is received by a controller configured to control the workflow to perform the one or more user-desired product properties.

3. The device of claim 2, wherein the transformed request comprises additional information to process the user request in accordance with specifications of the user, and the additional information comprises information to route and process the one or more user-desired product properties, and information to prioritize processing of the one or more user-desired product properties.

4. The device of claim 1, wherein the user request is received in a job definition format (JDF).

5. The device of claim 1, wherein the interface is configured to receive the user request via the Internet.

6. The device of claim 1, wherein the data comprises instructions written in Extensible Stylesheet Language.

7. The device of claim 1, wherein the processing circuitry is an XSLT processor.

8. The device of claim 1, wherein the processing circuitry applies XSL transformation to the user request to produce the transformed user request.

9. The device of claim 1, wherein the data is stored in a stylesheet within the storage device, and the stylesheet comprises instructions written in an XSL format.

10. A workflow processing device comprising:
a stylesheet having defined rules for processing a user request; and
processing circuitry configured to receive the user request, load the defined rules, and execute the defined rules to create a transformed request, and wherein the transformed request comprises instructions to automatically organize workflow to efficiently process the user request.

11. The device of claim 10, wherein the user request comprises one or more user-desired product properties, and wherein the transformed request comprises information to process the user request.

12. The device of claim 10, wherein the user request is received in a job definition format (JDF).

13. The device of claim 10, wherein the defined rules comprise instructions written in Extensible Stylesheet Language.

14. The device of claim 10, wherein the processing circuitry applies XSL transformation to the user request to produce the transformed request.

15. A workflow management system for managing workflow in a printing system, comprising:
one or more devices configured to process a user request, the one or more devices communicatively coupled to a communications medium; and
a workflow management device comprising:
a communications interface configured to receive the user request, the interface further configured to communicate with the one or more devices located external of the workflow management device;
a storage device configured to store rules data for processing the user request, the user request comprising one or more user-desired product properties; and
processing circuitry configured to process the request using the rules data and produce a transformed request, the transformed request comprising information for automatically organizing workflow through the system to process the one or more user-desired product properties to produce a user-desired product.

16. The system of claim 15, further comprising:
a controller configured to receive the transformed request and assign the one or more user-desired product properties to the one or more devices for processing using information from the transformed request.

17. The system of claim 15, wherein the user request is received in a job definition format (JDF).

18. The system of claim 15, wherein the rules data comprise instructions written in Extensible Stylesheet Language.

19. The system of claim 15, wherein the processing circuitry applies XSL transformation to the user request to produce the transformed request.

20. A workflow assignment method comprising:
receiving a user request, the request having one or more user-desired product properties;
creating a stylesheet having defined rules for processing the user request;
loading the defined rules and the user request into a processing circuitry configured to process the user request; and
executing the defined rules to create a transformed user request, the transformed user request comprising additional information to automatically organize workflow to process the one or more user-desired product properties to produce a user-desired product.

21. The method of claim 20, further comprising:
receiving the transformed user request in a controller; and
controlling the workflow to process the one or more user-desired product properties using information from the transformed user request.

22. The method of claim 20, wherein the receiving comprises receiving the user request in a job definition format (JDF).

23. The method of claim 20, wherein the creating comprises creating the stylesheet in XSL format having instructions written in Extensible Stylesheet Language.

24. The method of claim 22, wherein the receiving further comprises receiving the user request via the Internet.

25. The method of claim 20, wherein the loading and the executing are performed by an XSLT processor.

26. The method of claim 20, wherein the creating the transformed user request comprises applying the defined rules and using XSL transformation to the user request, and the transformed user request comprise definition of workflow tasks to be performed, settings and properties for the workflow tasks, and one or more user-desired product properties to produce a user-desired product.

27. A method of managing workflow in a printing system, comprising:
receiving a user request having one or more user-desired product properties in a first processor;
generating a document with the one or more user-desired product properties;
defining a set of rules using which the document is processed; and
processing the document using the defined set of rules to create a modified document, the modified document having instructions to organize workflow to perform the one or more user-desired product properties to produce a user-desired product.

28. The method of claim 27, further comprising:
transmitting the modified document to a second processor configured to route the workflow to process the user request having the one or more user-desired product properties using instructions from the modified document.

29. The method of claim 27, wherein the instructions comprise instructions to assemble the workflow, and instructions to decide how the one or more user-desired product properties should be processed through the printing system.

30. A workflow assignment system comprising:
means for receiving a user request, the request having one or more user-desired product properties;
means for creating a stylesheet having defined rules for processing the user request;
means for loading the defined rules and the user request into a processing means configured to process the user request; and
means for executing the defined rules to create a transformed user request, the transformed user request comprising additional information to organize workflow to perform the one or more user-desired product properties to produce a user-desired product.

31. An article of manufacture comprising:
processor-usable media embodying programming configured to cause a processing circuitry of a workflow management device to:
receive a user request, the request having one or more user-desired product properties;
create a stylesheet having defined rules for processing the user request;
load the defined rules and the user request into a processing circuitry configured to process the user request; and
execute the defined rules to create a transformed user request, the transformed user request comprising additional information to organize workflow to perform the one or more user-desired product properties to produce a user-desired product.
